(19) United States
(12) Patent Application Publication
(10) Pub. No.: US 2025/0362792 A1
(43) Pub. Date: Nov. 27, 2025

(54) MANAGING A MAGNIFICATION LEVEL OF A USER INTERFACE OF A DISPLAY OF AN INFORMATION HANDLING SYSTEM

(71) Applicant: Dell Products L.P., Round Rock, TX (US)

(72) Inventors: Bhavani Anandakrishnan, Chennai (IN); Jyothi Bandakka Nanjappa, Bangalore (IN); Vivekanandh Narayanasamy Rajagopalan, Bangalore (IN)

(21) Appl. No.: 18/669,843

(22) Filed: May 21, 2024

(51) Int. Cl. G06F 3/04847; G06F 3/04845

(52) U.S. Cl. CPC G06F 3/04847; G06F 3/04845; G06F 2203/04806

(57) ABSTRACT

Managing a magnification of an user interface of a display of an IHS including generating a form slider interface that includes i) a slide guide element and ii) a selection element; integrating the form slider interface into an UI such that the form slider interface is adjacent input fields; detecting first user input indicating translation of the selection element from an initial position to a first position adjacent a first input field; adjusting a magnification of the first input field from a first magnification level to a second magnification level; detecting second user input indicating translation of the selection element from the first position to a second position adjacent a second input field; adjusting the magnification of the first input field from the second magnification level to the first magnification level, and adjusting a magnification of the second input field from the first magnification level to the second magnification level.

### BACKGROUND

### Field of the Disclosure

The disclosure relates generally to an information handling system and, in particular, managing a magnification level of a user interface of a display of an information handling system.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use, such as financial transaction processing, airline reservations, enterprise data storage, or global communications. In addition, information handling systems may include a variety of hardware and software components that may be configured to process, store, and communicate information and may include one or more computer systems, data storage systems, and networking systems.

When designing user interfaces, it can be important to consider accessibility for all users, including those with visual disabilities, to provide an equivalent user experience for everyone.

### SUMMARY

Innovative aspects of the subject matter described in this specification may be embodied in a method of managing a magnification of a user interface of a display of an information handling system, the method including: providing a user interface (UI) comprising a plurality of input fields and a form slider interface that includes i) a slide guide element and ii) a selection element, wherein the form slider interface is adjacent the plurality of input fields; detecting first user input indicating translation of the selection element of the form slider interface from an initial position to a first position, the first position adjacent a first input field of the plurality of input fields; in response to the selection element at the first position adjacent to the first input field, adjusting a magnification of the first input field from a first magnification level to a second magnification level, the second magnification level greater than the first magnification level; detecting second user input indicating translation of the selection element of the form slider interface from the first position to a second position, the second position adjacent a second input field of the plurality of input fields; in response to the selection element at the second position adjacent to the second input field: i) adjusting the magnification of the first input field from the second magnification level to the first magnification level, and ii) adjusting a magnification of the second input field from the first magnification level to the second magnification level.

Other embodiments of these aspects include corresponding systems, apparatus, and computer programs, configured to perform the actions of the methods, encoded on computer storage devices.

These and other embodiments may each optionally include one or more of the following features. For instance, prior to detecting the first user input, the magnification of each of the plurality of input fields is at the first magnification level. After adjusting magnification of the first input field from the first magnification level to the second magnification level, receiving additional user input at the first input field. Receiving user input indicating an intelligent mode of the form slider interface; and in response to the intelligent mode of the form slider interface, identifying the second input field as a required input field. Receiving user input indicating a nominal mode of the form slider interface; and in response to the nominal mode of the form slider interface, identifying the second input field as immediately following the first input field. In response to the selection element at the first position adjacent to the first input field, comparing the first magnification level of the first input field to a threshold; determining, based on the comparing, that the first magnification level of the first input field is equal to the threshold; and in response to determining that the first magnification level is equal to the threshold, maintaining the magnification level of the first input field. Determining, based on the comparing, that the first magnification level of the first input field is less than the threshold; and in response to determining that the first magnification level is less than the threshold, adjusting the magnification of the first input field from the first magnification level to the second magnification level.

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF DRAWINGS

FIG. 1 is a block diagram of selected elements of an embodiment of an information handling system.

FIG. 2 illustrates a block diagram of an information handling system for managing a magnification level of an user interface of a display.

FIG. 3 illustrates a method for managing a magnification level of a user interface of a display.

FIGS. 4A-4F illustrates the user interface.

### DESCRIPTION OF PARTICULAR EMBODIMENT(S)

This disclosure discusses methods and systems for managing a magnification level of a user interface of a display of an information handling system. In short, a form slider interface provides functionality of slide of the user interface along with magnification of input fields, enabling a user to seamlessly navigate/slide through the input fields. This functionality increases accuracy and overall efficiency of the user interface.

Specifically, this disclosure discusses a system and a method for managing a magnification of a user interface of a display of an information handling system, the method including: identifying a user interface (UI); identifying a plurality of input fields of the UI; generating a form slider interface that includes i) a slide guide element and ii) a selection element; integrating the form slider interface into the UI such that the form slider interface is adjacent the plurality of input fields; detecting first user input indicating translation of the selection element of the form slider interface from an initial position to a first position, the first position adjacent a first input field of the plurality of input fields; in response to the selection element at the first position adjacent to the first input field, adjusting a magnification of the first input field from a first magnification level to a second magnification level, the second magnification level greater than the first magnification level; detecting second user input indicating translation of the selection element of the form slider interface from the first position to a second position, the second position adjacent a second input field of the plurality of input fields; in response to the selection element at the second position adjacent to the second input field: i) adjusting the magnification of the first input field from the second magnification level to the first magnification level, and ii) adjusting a magnification of the second input field from the first magnification level to the second magnification level.

In the following description, details are set forth by way of example to facilitate discussion of the disclosed subject matter. It should be apparent to a person of ordinary skill in the field, however, that the disclosed embodiments are exemplary and not exhaustive of all possible embodiments.

For the purposes of this disclosure, an information handling system may include an instrumentality or aggregate of instrumentalities operable to compute, classify, process, transmit, receive, retrieve, originate, switch, store, display, manifest, detect, record, reproduce, handle, or utilize various forms of information, intelligence, or data for business, scientific, control, entertainment, or other purposes. For example, an information handling system may be a personal computer, a PDA, a consumer electronic device, a network storage device, or another suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include an instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory (SSD); as well as communications media such as wires, optical fibers, microwaves, radio waves, and other electromagnetic and/or optical carriers; and/or any combination of the foregoing.

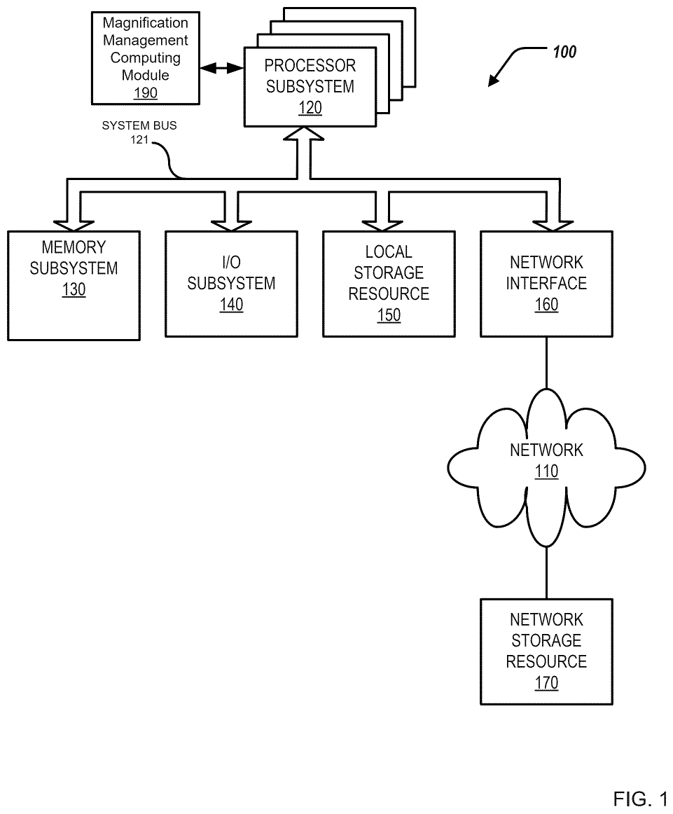

Particular embodiments are best understood by reference to FIGS. 1-4 wherein like numbers are used to indicate like and corresponding parts.

Turning now to the drawings, FIG. 1 illustrates a block diagram depicting selected elements of an information handling system 100 in accordance with some embodiments of the present disclosure. In various embodiments, information handling system 100 may represent different types of portable information handling systems, such as, display devices, head mounted displays, head mount display systems, smart phones, tablet computers, notebook computers, media players, digital cameras, 2-in-1 tablet-laptop combination computers, and wireless organizers, or other types of portable information handling systems. In one or more embodiments, information handling system 100 may also represent other types of information handling systems, including desktop computers, server systems, controllers, and microcontroller units, among other types of information handling systems. Components of information handling system 100 may include, but are not limited to, a processor subsystem 120, which may comprise one or more processors, and system bus 121 that communicatively couples various system components to processor subsystem 120 including, for example, a memory subsystem 130, an I/O subsystem 140, a local storage resource 150, and a network interface 160. System bus 121 may represent a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus.

As depicted in FIG. 1, processor subsystem 120 may comprise a system, device, or apparatus operable to interpret and/or execute program instructions and/or process data, and may include one or more processing resources such as a central processing unit (CPU), microprocessor, microcontroller, digital signal processor (DSP), application specific integrated circuit (ASIC), or another digital or analog circuitry configured to interpret and/or execute program instructions and/or process data. In some embodiments, processor subsystem 120 may interpret and/or execute program instructions and/or process data stored locally (e.g., in memory subsystem 130 and/or another component of information handling system). In the same or alternative embodiments, processor subsystem 120 may interpret and/or execute program instructions and/or process data stored remotely (e.g., in network storage resource 170).

Also in FIG. 1, memory subsystem 130 may comprise a system, device, or apparatus operable to retain and/or retrieve program instructions and/or data for a period of time (e.g., computer-readable media). Memory subsystem 130 may comprise random access memory (RAM), electrically erasable programmable read-only memory (EEPROM), a PCMCIA card, flash memory, magnetic storage, opto-magnetic storage, and/or a suitable selection and/or array of volatile or non-volatile memory that retains data after power to its associated information handling system, such as system 100, is powered down.

In information handling system 100, I/O subsystem 140 may comprise a system, device, or apparatus generally operable to receive and/or transmit data to/from/within information handling system 100. I/O subsystem 140 may represent, for example, a variety of communication interfaces, graphics interfaces, video interfaces, user input interfaces, and/or peripheral interfaces. In various embodiments, I/O subsystem 140 may be used to support various peripheral devices, such as a touch panel, a display adapter, a keyboard, an accelerometer, a touch pad, a gyroscope, an IR sensor, a microphone, a sensor, a camera, or another type of peripheral device.

Local storage resource 150 may comprise computer-readable media (e.g., hard disk drive, floppy disk drive, CD-ROM, and/or other types of rotating storage media, flash memory, EEPROM, and/or another type of solid state storage media) and may be generally operable to store instructions and/or data. Likewise, the network storage resource may comprise computer-readable media (e.g., hard disk drive, floppy disk drive, CD-ROM, and/or other types of rotating storage media, flash memory, EEPROM, and/or other types of solid state storage media) and may be generally operable to store instructions and/or data.

In FIG. 1, network interface 160 may be a suitable system, apparatus, or device operable to serve as an interface between information handling system 100 and a network 110. Network interface 160 may enable information handling system 100 to communicate over network 110 using a suitable transmission protocol and/or standard, including, but not limited to, transmission protocols and/or standards enumerated below with respect to the discussion of network 110. In some embodiments, network interface 160 may be communicatively coupled via network 110 to a network storage resource 170. Network 110 may be a public network or a private (e.g., corporate) network. The network may be implemented as, or may be a part of, a storage area network (SAN), a personal area network (PAN), a local area network (LAN), a metropolitan area network (MAN), a wide area network (WAN), a wireless local area network (WLAN), a virtual private network (VPN), an intranet, the Internet or another appropriate architecture or system that facilitates the communication of signals, data and/or messages (generally referred to as data). Network interface 160 may enable wired and/or wireless communications (e.g., NFC or Bluetooth) to and/or from information handling system 100.

In particular embodiments, network 110 may include one or more routers for routing data between client information handling systems 100 and server information handling systems 100. A device (e.g., a client information handling system 100 or a server information handling system 100) on network 110 may be addressed by a corresponding network address, including, for example, an Internet protocol (IP) address, an Internet name, a Windows Internet name service (WINS) name, a domain name or other system name. In particular embodiments, network 110 may include one or more logical groupings of network devices such as, for example, one or more sites (e.g., customer sites) or subnets. As an example, a corporate network may include potentially thousands of offices or branches, each with its own subnet (or multiple subnets) having many devices. One or more client information handling systems 100 may communicate with one or more server information handling systems 100 via any suitable connection including, for example, a modem connection, a LAN connection including the Ethernet, or a broadband WAN connection including DSL, Cable, Ti, T3, Fiber Optics, Wi-Fi, or a mobile network connection including GSM, GPRS, 3G, or WiMax.

Network 110 may transmit data using a desired storage and/or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 110 and its various components may be implemented using hardware, software, or any combination thereof.

The information handling system 100 can also include a magnification management computing module 190. The magnification management computing module 190 can be in communication with the processor subsystem 120, or included by the processor subsystem 120. In some examples, the magnification management computing module 190 is included by an embedded controller (EC) of the information handling system 100. In some examples, the magnification management computing module 190 is included by the baseband management controller of the information handling system 100.

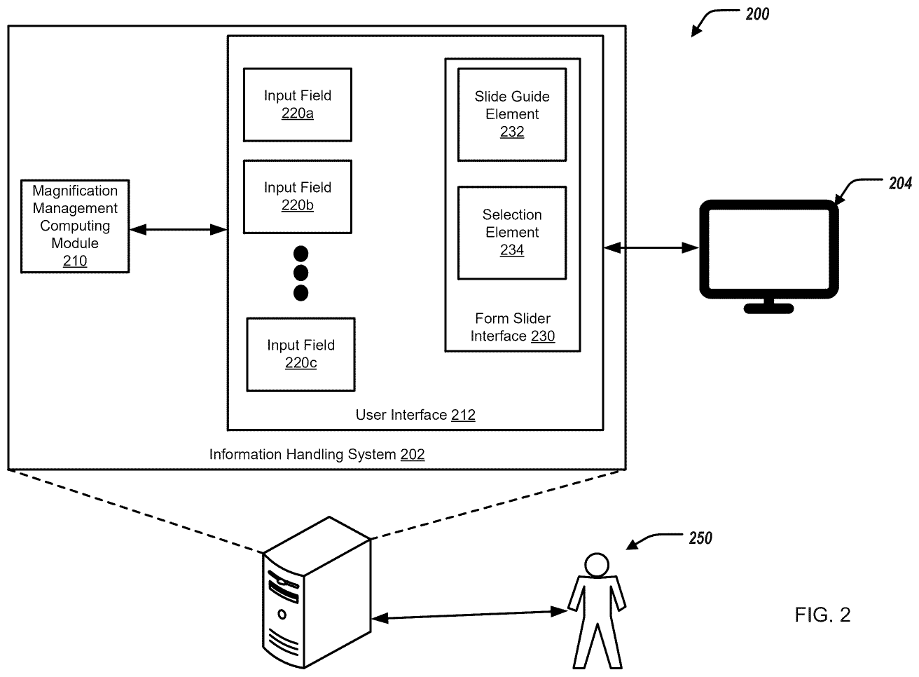

Turning to FIG. 2, FIG. 2 illustrates an environment 200 including an information handling system 202 and a display device 204. The information handling system 202 can include a magnification management computing module 210 and an interactable user interface (UI) 212. In some examples, the information handling system 202 is similar to, or includes, the information handling system 100 of FIG. 1. In some examples, the magnification management computing module 210 is the same, or substantially the same, as the magnification management computing module 190 of FIG. 1.

The user interface 212 can include a plurality of input fields 220a, 220b, . . . , 220n (collectively referred to as input fields 220). The user interface 212 can further include a form slider interface 230. The form slider interface 230 can include a slide guide element 232 and a selection element 234.

The input fields 220 can include heterogeneous types of input fields, such as a toggle button, drop down menu, text box, and the like.

In short, the form slider interface 230 provides functionality of slide of the user interface 212 along with magnification of the input fields 220, enabling the user 250 to seamlessly navigate/slide through the input fields 220. This functionality increases accuracy and overall efficiency of the user interface 212.

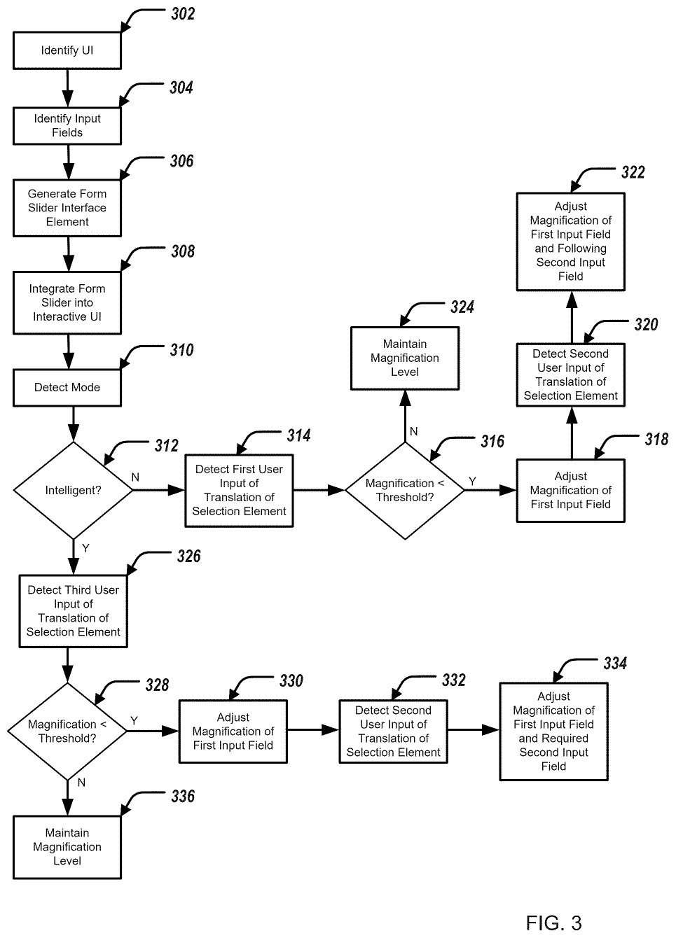

FIG. 3 illustrates a flowchart depicting selected elements of an embodiment of a method 300 for managing a magnification level of a user interface of a display. The method 300 may be performed by the information handling system 100, the information handling system 202 and/or the magnification management computing module 210, and with reference to FIGS. 1-2. It is noted that certain operations described in method 300 may be optional or may be rearranged in different embodiments.

The magnification management computing module 210 identifies the user interface 212, at 302. The magnification management computing module 210 identifies the plurality of input fields 220, at 304. In some examples, each of the input fields 220—e.g., upon initialization of the user interface 212—can have a magnification of a first magnification level. In some examples, the first magnification can be a standard magnification level, or 100% magnification level. In some examples, the first magnification can be a maximum magnification level, or 225% magnification level.

The magnification management computing module 210 generates the form slider interface 230, at 306. The magnification management computing module 210 can generate the form slider interface 230 to include i) the slide guide element 232 and ii) the selection element 234.

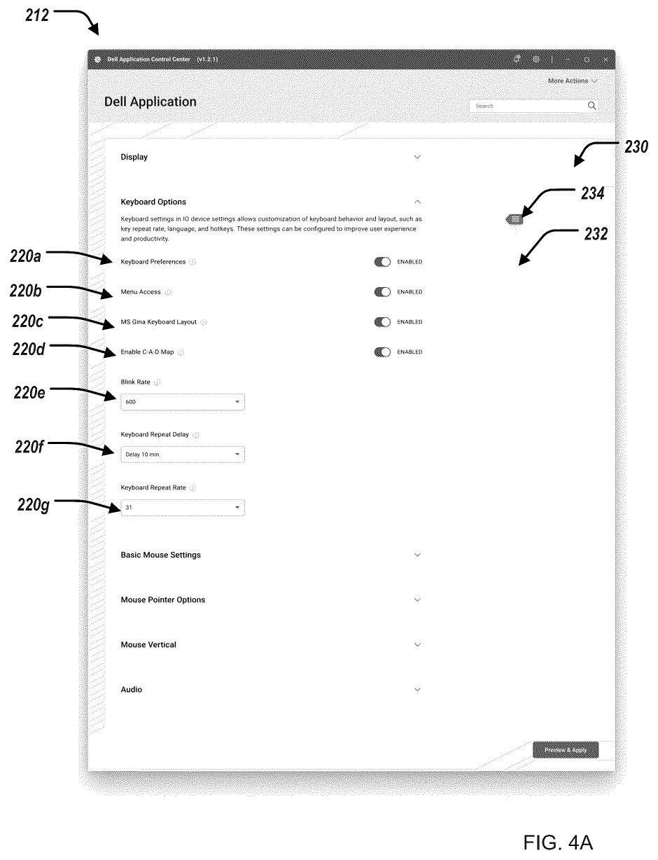

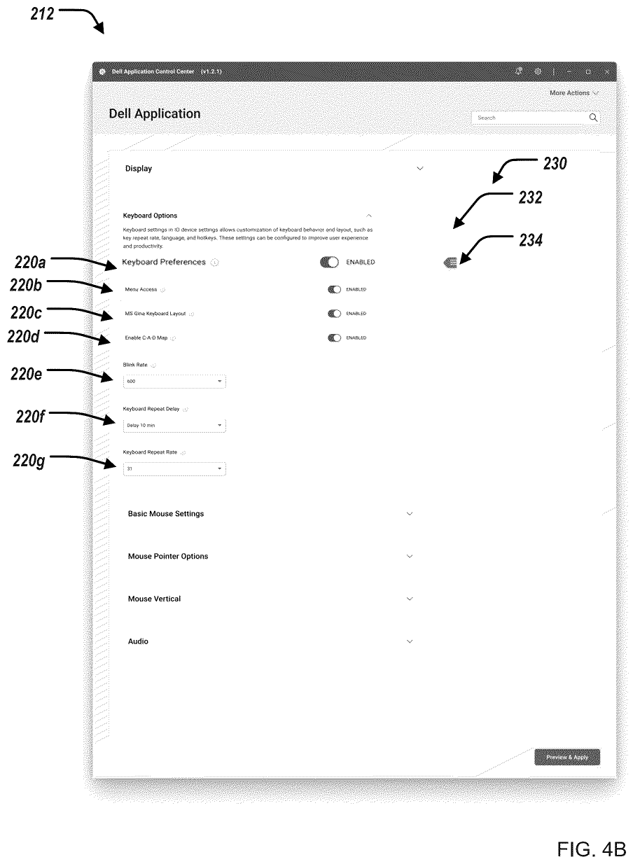

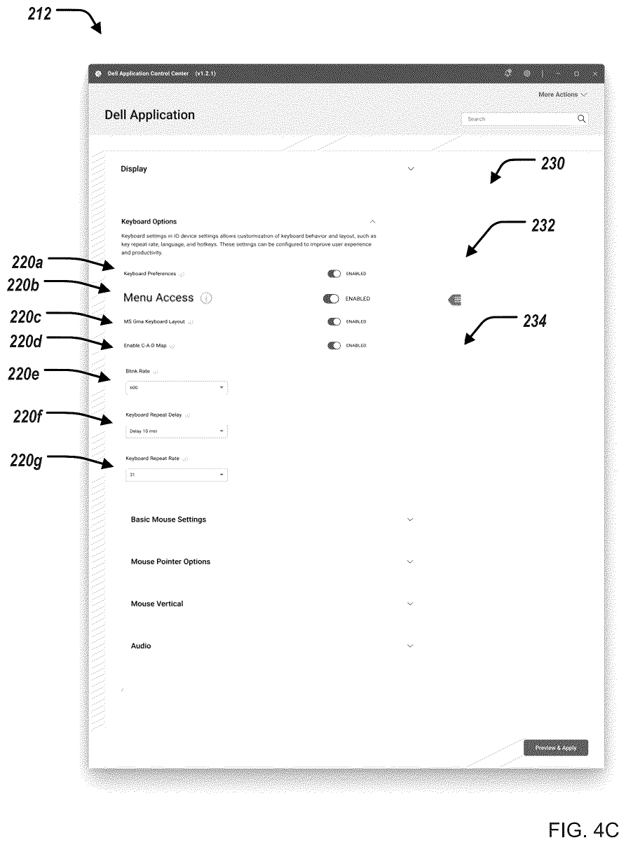

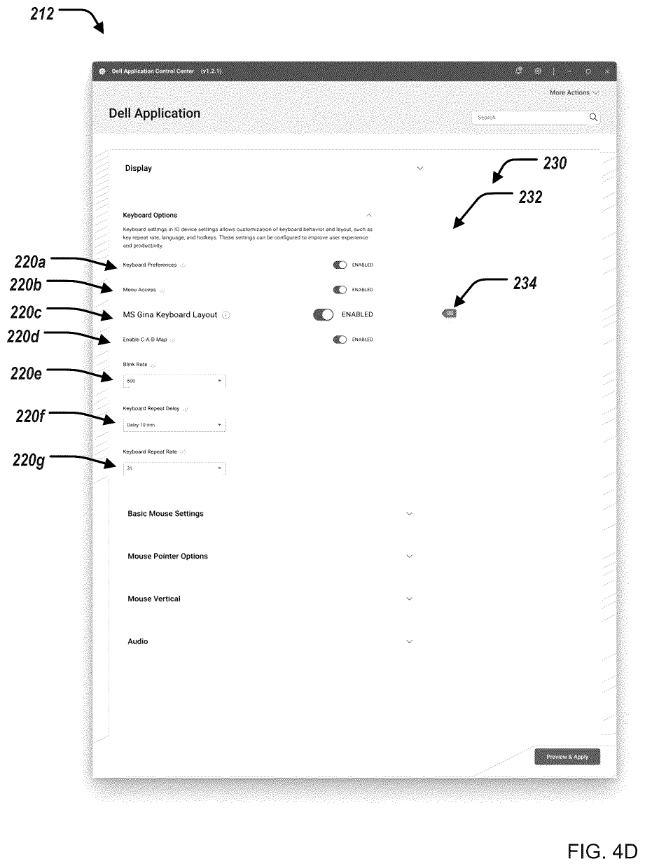

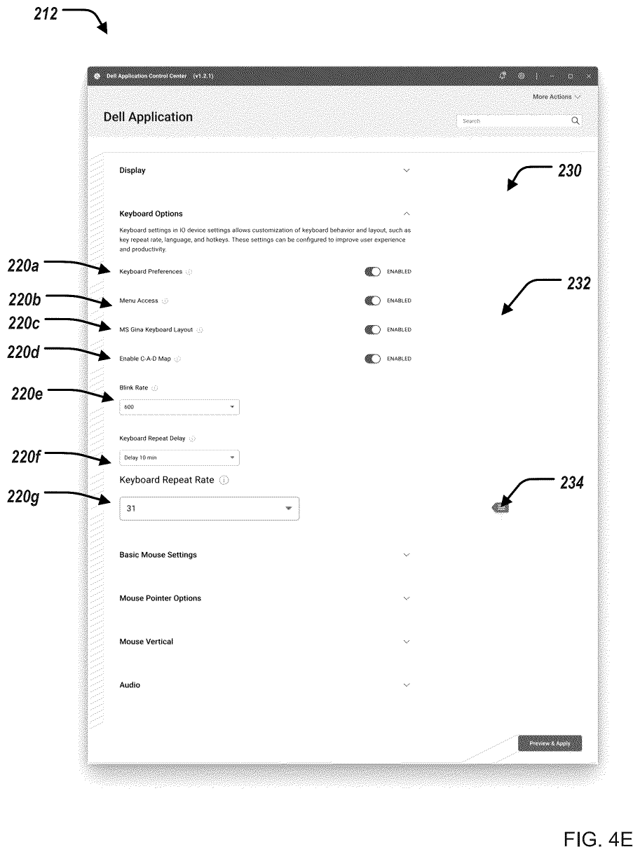

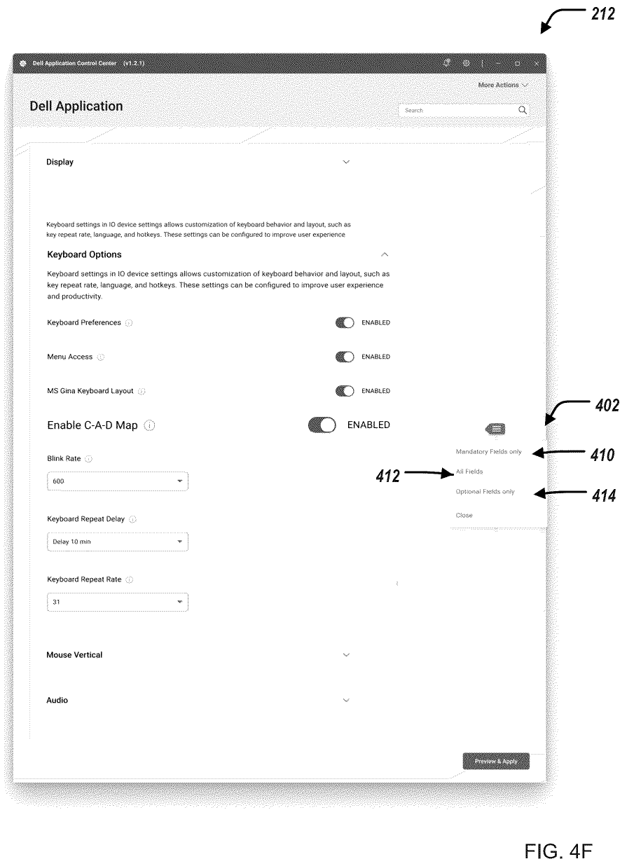

The magnification management computing module 210 integrates the form slider interface 230 into the user interface 212, at 308. Specifically, the magnification management computing module 210 integrates the form slider interface 230 into the user interface 212 such that the form slider interface 230 is adjacent to, or proximate to, the input fields 220. FIG. 4A illustrates the user interface 212 including the form slider interface 230 adjacent to the input fields 220. The selection element 234 can be positioned along the slide guide element 232, and in an initial position.

In other words, the magnification management computing module 210 can providing the user interface 212 to include the input fields 220 and the form slider interface 230 that includes i) the slide guide element 232 and ii) the selection element 234, wherein the form slider interface 230 is adjacent the input fields 220.

The magnification management computing module 210 receives user input indicating a mode of the form slider interface 230, at 312. Specifically, the mode of the form slider interface 230 can include an “intelligent” mode or a “nominal” mode. In some examples, the magnification management computing module 210 determines that the user input indicates a “nominal” mode of the form slider interface 230, at 312. That is, the mode of the form slider interface 230 is not an “intelligent” mode. The “nominal” mode of the form slider interface 230 indicates the form slider interface 230 browses through each of the input fields 220 sequentially without considering if the input fields 220 are mandatory. That is, all input fields 220 are considered for scrolling, as described further herein.

In response to determining that the mode of the form slider interface 230 is a “nominal mode,” the magnification management computing module 210 detects, at a first time, first user input indicating translation of the selection element 234 along the slide guide element 232 from the initial position to a first position, at 314. FIG. 4B illustrates the user interface 212 with the selection element 234 of the form slider interface 230 at the first position. That is, the user 250 has provided input indicating translation of the selection element 234 along the slide guide 232 to the first position that is adjacent to the input field 220a.

The magnification computing module 210, in response to translation of the selection element 232 to the first position adjacent to the input field 220a, compares the first magnification level of the input field 220a to a threshold, at 316. In some examples, the magnification computing module 210 determines, based on the comparing, that the first magnification level of the input field 220a is less than the threshold. For example, the threshold can be an internal setting associated with the information handling system 202-a maximum magnification associated with the user interface 212 and/or the display device 204. For example, the threshold can be 225% magnification level.

That magnification computing module 210, in response to determining that the first magnification level of the input field 220a is less than the threshold, adjusts the magnification of the input field 220a from the first magnification level to a second magnification level, at 318. The second magnification level is greater than the first magnification level. For example, the input field 220a can include text and a radio button that are magnified to the second magnification level. That is, the magnification level of the input field 220a is greater than the magnification level of the remaining input fields 220. That is, the input field 220a is associated with the second magnification that is greater than the first magnification of the remaining input fields 220b-220g.

In some examples, after adjusting the magnification of the input field 220a from the first magnification level to the second magnification level, the user 250 can provide additional user input at the input field 220a. For example, the user 250 can provide additional user input adjusting a state of the radio button of the input field 220a.

The magnification management computing module 210 detects, at a second time after the first time, second user input indicating translation of the selection element 234 along the slide guide element 232 from the first position to a second position, at 320. FIG. 4C illustrates the user interface 212 with the selection element 234 of the form slider interface 230 at the second position. That is, the user 250 has provided input indicating translation of the selection element 234 along the slide guide 232 to the second position that is adjacent to the input field 220b.

The magnification computing module 210, in response to translation of the selection element 232 to the second position adjacent to the input field 220b, adjusts the magnification of the input field 220b from the first magnification level to the second magnification level, at 322. Furthermore, the magnification computing module 210, in response to translation of the selection element 232 to the second position adjacent to the input field 220b, adjusts the magnification of the input field 220a from the second magnification level to the first magnification level, at 322. For example, the input field 220b can include text and a radio button that are magnified to the second magnification level. That is, the magnification level of the input field 220b is greater than the magnification level of the remaining input fields 220. That is, the input field 220b is associated with the second magnification that is greater than the first magnification of the remaining input fields 220a and 220c-220g. Moreover, the magnification of the input field 220a can be reverted back from the second magnification level to the first magnification level.

In some examples, after adjusting the magnification of the input field 220b from the first magnification level to the second magnification level, the user 250 can provide additional user input at the input field 220b. For example, the user 250 can provide additional user input adjusting a state of the radio button of the input field 220b.

In some examples, the magnification computing module 210 determines, based on the comparing (at 316), that the first magnification level of the input field 220a is equal to the threshold. That magnification computing module 210, in response to determining that the first magnification level of the input field 220a is equal to the threshold, maintains the magnification level of the input field 220a, at 324. That is, the magnification computing module 210 maintains the first magnification level of the input field 220a at the maximum magnification. For example, the magnification computing module 210 maintains the magnification level of the input field 220a at 225%.

In some examples, when the mode of the form slider interface 230 is indicated as the “nominal” or “normal” mode, when the user 250 provides input indicating translation of the selection element 234 (sliding of the selection element 234 along the slide guide element 232), the form slider interface 230 translates the selection element 234 to the input field 220 that immediately follows the input field 220a. That is, the form slider interface 230 translates the selection element 234 to the input field 230b as input field 230b immediately follows, or is after, the input field 230a (as viewed from the standard top to bottom view).

In a use case example, the user 250 accesses the user interface 212 and selects the form slider interface 230 in the “normal” mode. The form slider interface 230 tracks the slide value and moves the selection element 234 to the next input field. The next input field is magnified and the previous input field is restored to its previous magnification.

In some examples, the magnification management computing module 210 determines that the user input indicates the “intelligent” mode of the form slider interface 230, at 312. That is, the mode of the form slider interface 230 is an “intelligent” mode. The “intelligent” mode of the form slider interface 230 indicates the form slider interface 230 browses through only the “required” input fields 220 sequentially, and then loops back to slide through the “optional” input fields 220. That is, only the “required” input fields 220 are considered for magnification as a first pass, and then the remaining input fields 220 are selected sequentially for magnification as a second pass, as described further herein.

In response to determining that the mode of the form slider interface 230 is an “intelligent mode,” the magnification management computing module 210 detects, at a first time, first user input indicating translation of the selection element 234 along the slide guide element 232 from the initial position to a third position, at 326. FIG. 4D illustrates the user interface 212 with the selection element 234 of the form slider interface 230 at the third position. That is, the user 250 has provided input indicating translation of the selection element 234 along the slide guide 232 to the third position that is adjacent to the input field 220c.

The magnification computing module 210, in response to translation of the selection element 232 to the third position adjacent to the input field 220c, compares the first magnification level of the input field 220c to the threshold, at 328. In some examples, the magnification computing module 210 determines, based on the comparing, that the first magnification level of the input field 220c is less than the threshold.

That magnification computing module 210, in response to determining that the first magnification level of the input field 220c is less than the threshold, adjusts the magnification of the input field 220c from the first magnification level to the second magnification level, at 330. For example, the input field 220c can include text and a radio button that are magnified to the second magnification level. That is, the magnification level of the input field 220c is greater than the magnification level of the remaining input fields 220. That is, the input field 220c is associated with the second magnification that is greater than the first magnification of the remaining input fields 220a, 220b, and 220d-220g.

In some examples, after adjusting the magnification of the input field 220c from the first magnification level to the second magnification level, the user 250 can provide additional user input at the input field 220c. For example, the user 250 can provide additional user input adjusting a state of the radio button of the input field 220c.

The magnification management computing module 210 detects, at a second time after the first time, second user input indicating translation of the selection element 234 along the slide guide element 232 from the third position to a fourth position, at 332. FIG. 4E illustrates the user interface 212 with the selection element 234 of the form slider interface 230 at the fourth position. That is, the user 250 has provided input indicating translation of the selection element 234 along the slide guide 232 to the fourth position that is adjacent to the input field 220g.

The magnification computing module 210, in response to translation of the selection element 232 to the fourth position adjacent to the input field 220g, adjusts the magnification of the input field 220g from the first magnification level to the second magnification level, at 334. Furthermore, the magnification computing module 210, in response to translation of the selection element 232 to the fourth position adjacent to the input field 220g, adjusts the magnification of the input field 220c from the second magnification level to the first magnification level, at 334. For example, the input field 220g can include text and a drop-down menu that are magnified to the second magnification level. That is, the magnification level of the input field 220g is greater than the magnification level of the remaining input fields 220. That is, the input field 220g is associated with the second magnification that is greater than the first magnification of the remaining input fields 220a-220f. Moreover, the magnification of the input field 220c can be reverted back from the second magnification level to the first magnification level.

In some examples, after adjusting the magnification of the input field 220g from the first magnification level to the second magnification level, the user 250 can provide additional user input at the input field 220g. For example, the user 250 can provide additional user input selecting one of the options of the drop-down menu of the input field 220g.

In some examples, the magnification computing module 210 determines, based on the comparing (at 328), that the first magnification level of the input field 220c is equal to the threshold. That magnification computing module 210, in response to determining that the first magnification level of the input field 220c is equal to the threshold, maintains the magnification level of the input field 220c, at 336. That is, the magnification computing module 210 maintains the first magnification level of the input field 220c at the maximum magnification. For example, the magnification computing module 210 maintains the magnification level of the input field 220c at 225%.

In some examples, when the mode of the form slider interface 230 is indicated as “intelligent,” when the user 250 provides input indicating translation of the selection element 234 (sliding of the selection element 234 along the slide guide element 232), the form slider interface 230 translates the selection element 234 to the input field 220 that is the next input field 220 that is required and that follows the input field 220c. That is, the form slider interface 230 translates the selection element 234 to the input field 230g as input field 230g is the next input field that follows, or is after, the input field 230c (as viewed from the standard top to bottom view) and is required.

In a use case example, the user 250 accesses the user interface 212 and selects the form slider interface 230 in the “intelligent” mode. The form slider interface 230 tracks the slide value and moves the selection element 234 to the next required input field. The next required input field is magnified and the previous input field is restored to its previous magnification. Once all required fields are navigated, the form slider interface 230 scrolls back to the “optional” input fields.

FIG. 4F illustrates the user interface 212, including the menu 402 that corresponds to mode selection of the form slider interface 230 (i.e., step 312 of FIG. 3). For example, when 412 is selected, then the form slider interface 230 is in the “normal” or “nominal mode.” For example, when 410 is selected, then the form slider interface 230 is in the “intelligent” mode. For example, when 414 is selected, the optional fields (e.g., of the second pass) are shown.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A computer-implemented method of managing a magnification of a user interface of a display of an information handling system, the method including:
providing a user interface (UI) comprising a plurality of input fields and a form slider interface that includes i) a slide guide element and ii) a selection element, wherein the form slider interface is adjacent the plurality of input fields;
detecting first user input indicating translation of the selection element of the form slider interface from an initial position to a first position, the first position adjacent a first input field of the plurality of input fields;
in response to the selection element at the first position adjacent to the first input field, adjusting a magnification of the first input field from a first magnification level to a second magnification level, the second magnification level greater than the first magnification level;
detecting second user input indicating translation of the selection element of the form slider interface from the first position to a second position, the second position adjacent a second input field of the plurality of input fields;
in response to the selection element at the second position adjacent to the second input field:
i) adjusting the magnification of the first input field from the second magnification level to the first magnification level, and
ii) adjusting a magnification of the second input field from the first magnification level to the second magnification level.

2. The computer-implemented method of claim 1, wherein prior to detecting the first user input, the magnification of each of the plurality of input fields is at the first magnification level.

3. The computer-implemented method of claim 1, after adjusting magnification of the first input field from the first magnification level to the second magnification level, receiving additional user input at the first input field.

4. The computer-implemented method of claim 1, further including:
receiving user input indicating an intelligent mode of the form slider interface; and
in response to the intelligent mode of the form slider interface, identifying the second input field as a required input field.

5. The computer-implemented method of claim 1, further including:
receiving user input indicating a nominal mode of the form slider interface; and
in response to the nominal mode of the form slider interface, identifying the second input field as immediately following the first input field.

6. The computer-implemented method of claim 1, further including:
in response to the selection element at the first position adjacent to the first input field, comparing the first magnification level of the first input field to a threshold;
determining, based on the comparing, that the first magnification level of the first input field is equal to the threshold; and
in response to determining that the first magnification level is equal to the threshold, maintaining the magnification level of the first input field.

7. The computer-implemented method of claim 6, further including:
determining, based on the comparing, that the first magnification level of the first input field is less than the threshold; and
in response to determining that the first magnification level is less than the threshold, adjusting the magnification of the first input field from the first magnification level to the second magnification level.

8. An information handling system comprising a processor having access to memory media storing instructions executable by the processor to perform operations, comprising:
providing a user interface (UI) comprising a plurality of input fields and a form slider interface that includes i) a slide guide element and ii) a selection element, wherein the form slider interface is adjacent the plurality of input fields; detecting first user input indicating translation of the selection element of the form slider interface from an initial position to a first position, the first position adjacent a first input field of the plurality of input fields;
in response to the selection element at the first position adjacent to the first input field, adjusting a magnification of the first input field from a first magnification level to a second magnification level, the second magnification level greater than the first magnification level;
detecting second user input indicating translation of the selection element of the form slider interface from the first position to a second position, the second position adjacent a second input field of the plurality of input fields;
in response to the selection element at the second position adjacent to the second input field:
i) adjusting the magnification of the first input field from the second magnification level to the first magnification level, and
ii) adjusting a magnification of the second input field from the first magnification level to the second magnification level.

9. The information handling system of claim 8, wherein prior to detecting the first user input, the magnification of each of the plurality of input fields is at the first magnification level.

10. The information handling system of claim 8, the operations further including after adjusting magnification of the first input field from the first magnification level to the second magnification level, receiving additional user input at the first input field.

11. The information handling system of claim 8, the operations further including:
receiving user input indicating an intelligent mode of the form slider interface; and
in response to the intelligent mode of the form slider interface, identifying the second input field as a required input field.

12. The information handling system of claim 8, the operations further including:
receiving user input indicating a nominal mode of the form slider interface; and
in response to the nominal mode of the form slider interface, identifying the second input field as immediately following the first input field.

13. The information handling system of claim 8, the operations further including:
in response to the selection element at the first position adjacent to the first input field, comparing the first magnification level of the first input field to a threshold;
determining, based on the comparing, that the first magnification level of the first input field is equal to the threshold; and
in response to determining that the first magnification level is equal to the threshold, maintaining the magnification level of the first input field.

14. The information handling system of claim 13, the operations further including:
determining, based on the comparing, that the first magnification level of the first input field is less than the threshold; and
in response to determining that the first magnification level is less than the threshold, adjusting the magnification of the first input field from the first magnification level to the second magnification level.

15. A non-transitory computer-readable medium storing software comprising instructions executable by one or more computers which, upon such execution, cause the one or more computers to perform operations comprising:
providing a user interface (UI) comprising a plurality of input fields and a form slider interface that includes i) a slide guide element and ii) a selection element, wherein the form slider interface is adjacent the plurality of input fields;
detecting first user input indicating translation of the selection element of the form slider interface from an initial position to a first position, the first position adjacent a first input field of the plurality of input fields;
in response to the selection element at the first position adjacent to the first input field, adjusting a magnification of the first input field from a first magnification level to a second magnification level, the second magnification level greater than the first magnification level;
detecting second user input indicating translation of the selection element of the form slider interface from the first position to a second position, the second position adjacent a second input field of the plurality of input fields;
in response to the selection element at the second position adjacent to the second input field:
i) adjusting the magnification of the first input field from the second magnification level to the first magnification level, and
ii) adjusting a magnification of the second input field from the first magnification level to the second magnification level.

16. The non-transitory computer-readable medium of claim 15, wherein prior to detecting the first user input, the magnification of each of the plurality of input fields is at the first magnification level.

17. The non-transitory computer-readable medium of claim 15, the operations further including after adjusting magnification of the first input field from the first magnification level to the second magnification level, receiving additional user input at the first input field.

18. The non-transitory computer-readable medium of claim 15, the operations further including:
receiving user input indicating an intelligent mode of the form slider interface; and
in response to the intelligent mode of the form slider interface, identifying the second input field as a required input field.

19. The non-transitory computer-readable medium of claim 15, the operations further including:
receiving user input indicating a nominal mode of the form slider interface; and
in response to the nominal mode of the form slider interface, identifying the second input field as immediately following the first input field.

20. The non-transitory computer-readable medium of claim 15, the operations further including:
in response to the selection element at the first position adjacent to the first input field, comparing the first magnification level of the first input field to a threshold;
determining, based on the comparing, that the first magnification level of the first input field is equal to the threshold; and
in response to determining that the first magnification level is equal to the threshold, maintaining the magnification level of the first input field.
